(19) United States
(12) Patent Application Publication
(10) Pub. No.: US 2026/0300717 A1
(43) Pub. Date: Oct. 1, 2026

(54) DISTRIBUTIONAL REINFORCEMENT LEARNING METHOD FOR DECISION MAKING IN OFFLINE ENVIRONMENT AND COMPUTING DEVICE FOR PERFORMING SAME

(71) Applicant: FOUNDATION OF SOONGSIL UNIVERSITY-INDUSTRY COOPERATION, Seoul (KR)

(72) Inventors: MINHAE KWON, Seoul (KR); JAEHWI LEE, Seoul (KR); CHANIN EOM, Seoul (KR)

(21) Appl. No.: 19/297,216

(22) Filed: Aug. 12, 2025

(30) Foreign Application Priority Data
Mar. 27, 2025 (KR) 10-2025-0039537
May 20, 2025 (KR) 10-2025-0065569

(51) Int. Cl. G06N 3/08; G06N 3/045; G06N 3/048

(52) U.S. Cl. CPC G06N 3/08; G06N 3/045; G06N 3/048

(57) ABSTRACT

A learning method includes generating a data set by acquiring data on a state, an action, and a reward for each time step for a preset environment, and training a neural network including a value network, a critic network, and an actor network based on the data set. The training includes inputting a state to the value network and outputting a first prediction value, which is a scalar value, converting the first prediction value into a first prediction probability distribution for each interval based on the first prediction value, calculating a first target value, which corresponds to the first prediction value and is a scalar value, converting the first target value into a first target probability distribution for each interval based on the first target value, and updating parameters of the value network based on the first prediction probability distribution and the first target probability distribution.

### CROSS-REFERENCE TO RELATED APPLICATION AND CLAIM OF PRIORITY

This application claims the benefit under 35 USC § 119 of Korean Patent Application Nos. 10-2025-0039537, filed on Mar. 27, 2025 and 10-2025-0065569, filed on May 20, 2025, in the Korean Intellectual Property Office, the entire disclosure of which is incorporated herein by reference for all purposes.

### BACKGROUND

### 1. Field

Embodiments of the present disclosure relate to a distributional reinforcement learning technique for decision making in an offline environment.

### 2. Description of Related Art

In existing decision making systems, methods based on reinforcement learning (RL) are actively being studied. In particular, traditional reinforcement learning algorithms that use scalar-type return values have been utilized to optimize policies in various environments. However, such methods have a structural limitation in that they do not sufficiently reflect the uncertainty of the environment. Since the methods do not take into account the variance or risk in the return values, they are inadequate for a long-term strategy establishment in a complex or dynamic environment.

In addition, online reinforcement learning has the limitation in that it may cause cost or safety issues because it requires real-time interaction, whereas offline reinforcement learning has the advantage of being able to learn without additional interaction with the environment by utilizing data collected in advance. Therefore, a method is required that can perform efficient decision making through offline reinforcement learning while addressing the problems of scalar-based reinforcement learning.

Examples of related art include Korean Unexamined Patent Application Publication No. 10-2025-0031477 (2025.03.07).

### SUMMARY

Embodiments of the present disclosure are intended to provide a distributional reinforcement learning technique that can make efficient decisions through offline reinforcement learning while addressing the problems of scalar-based reinforcement learning.

A learning method according to an embodiment of the present disclosure is a method performed on a computing device that includes one or more processors and a memory storing one or more programs executed by the one or more processors, the learning method including generating a data set by acquiring data on a state, an action, and a reward for each time step for a preset environment, and training a neural network including a value network, a critic network, and an actor network based on the data set, in which the training of the neural network includes inputting a state to the value network and outputting a first prediction value, which is a scalar value, converting the first prediction value into a first prediction probability distribution for each interval based on the first prediction value, calculating a first target value, which corresponds to the first prediction value and is a scalar value, converting the first target value into a first target probability distribution for each interval based on the first target value, and updating parameters of the value network based on the first prediction probability distribution and the first target probability distribution.

The converting into the first prediction probability distribution may include inputting the first prediction value output from the value network into a first additional layer connected to an output terminal of the value network to output first logit values of a plurality of intervals, and calculating the first prediction probability distribution of each interval by applying a softmax function to each of the first logit values.

The generating of the data set may include calculating an n-step cumulative reward for each time step based on the reward for each time step, and in the calculating of the first target value, the first target value may be calculated based on an n-step cumulative reward for the current time step and the first prediction value of the value network for an n-th time step based on the current time step.

The converting into the first target probability distribution may include generating a first normal distribution, which is a normal distribution having the first target value as an average, dividing an interval between a minimum value and a maximum value of the first normal distribution into a plurality of intervals and calculating a first target probability distribution for each interval by integrating the first normal distribution for each interval of the first normal distribution.

The training of the neural network may further include inputting a state and an action to the critic network and outputting a second prediction value, which is a scalar value, converting the second prediction value into a second prediction probability distribution for each interval based on the second prediction value, calculating a second target value, which is a scalar value and corresponds to the second prediction value, converting the second target value into a second target probability distribution for each interval based on the second target value, and updating parameters of the critic network based on the second prediction probability distribution and the second target probability distribution.

The converting into the second prediction probability distribution may include inputting the second prediction value output from the critic network into a second additional layer connected to an output terminal of the critic network to output second logit values of a plurality of intervals and calculating the second prediction probability distribution of each interval by applying a softmax function to each of the second logit values.

In the calculating of the second target value, the second target value may be calculated based on a reward for the current time step and the first prediction value of the value network for the next time step.

The converting into the second target probability distribution may include generating a second normal distribution which is a normal distribution having the second target value as an average, dividing an interval between a minimum value and a maximum value of the second normal distribution into a plurality of intervals, and calculating a second target probability distribution for each interval by integrating the second normal distribution for each interval of the second normal distribution.

The learning method may further include inputting a state into the actor network and outputting a predicted action, calculating an advantage function based on a difference between a mode value of the first prediction probability distribution for each interval and a mode value of the second prediction probability distribution for each interval, and updating parameters of the actor network based on a difference between the predicted action and the action in the data set and the advantage function.

A computing device according to an embodiment of the present disclosure includes one or more processors, a memory, and one or more programs, in which the one or more programs are stored in the memory and configured to be executed by the one or more processors, and the one or more programs include an instruction for generating a data set by acquiring data on a state, an action, and a reward for each time step for a preset environment and an instruction for training a neural network including a value network, a critic network, and an actor network based on the data set, and the instruction for training the neural network includes an instruction for inputting a state to the value network and outputting a first prediction value, which is a scalar value, an instruction for converting the first prediction value into a first prediction probability distribution for each interval based on the first prediction value, an instruction for calculating a first target value, which is a scalar value corresponding to the first prediction value, an instruction for converting the first target value into a first target probability distribution for each interval based on the first target value, and an instruction for updating parameters of the value network based on the first prediction probability distribution and the first target probability distribution.

### BRIEF DESCRIPTION OF THE DRAWINGS

FIG. 1 is a diagram showing a distributional reinforcement learning device for decision making in an offline environment according to an embodiment of the present disclosure.

FIG. 2 is a diagram schematically showing a neural network based on distributional reinforcement learning and its learning operation according to an embodiment of the present disclosure.

FIG. 3 is a flowchart for describing a distributional reinforcement learning method for decision making in an offline environment according to an embodiment of the present disclosure.

FIG. 4 is a flowchart showing a specific method for training a neural network based on distributional reinforcement learning according to an embodiment of the present disclosure.

FIG. 5 is a block diagram for illustratively describing a computing environment including a computing device suitable for use in exemplary embodiments.

### DETAILED DESCRIPTION

Hereinafter, specific embodiments of the present invention will be described with reference to the drawings. The following detailed description is provided to facilitate a comprehensive understanding of the methods, apparatuses, and/or systems described herein. However, this is only an example and the present invention is not limited thereto.

In describing embodiments of the present invention, if it is determined that a specific description of a related known function of the preset invention may unnecessarily obscure the gist of the present invention, the detailed description thereof will be omitted. The terms described below are terms defined in consideration of the functions in the present invention, and vary depending on the intention or custom of the user or operator. Therefore, the definition should be made based on the contents throughout this specification. The terminology used in the detailed description is for the purpose of describing embodiments of the present invention only and should not be construed as limiting. Unless expressly used otherwise, singular forms include plural forms. In this description, the terms “including” or “comprising” are intended to refer to certain features, numbers, steps, operations, elements, portions or combinations thereof, and should not be construed to exclude the presence or possibility of one or more other features, numbers, steps, operations, elements, portions or combinations thereof other than those described.

In addition, the terms first, second, etc. may be used to describe various components, but the components should not be limited by the terms. The terms may be used for the purpose of distinguishing one component from another component. For example, without departing from the scope of the present invention, a first component may be referred to as a second component, and similarly, a second component may also be referred to as a first component.

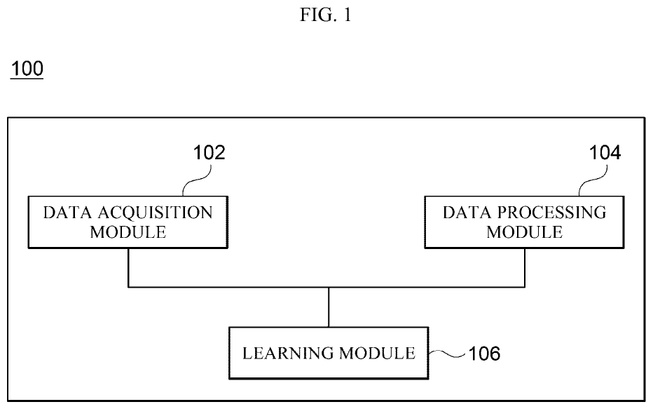

FIG. 1 is a diagram showing a distributional reinforcement learning device for decision making in an offline environment according to an embodiment of the present disclosure.

Referring to FIG. 1, a distributional reinforcement learning device 100 may include a data acquisition module 102, a data processing module 104, and a learning module 106.

The distributional reinforcement learning device 100 may be a device that performs learning in an offline environment. That is, the distributional reinforcement learning device 100 may be a device that performs distributional reinforcement learning based on data collected in advance without interacting with the environment.

The data acquisition module 102 may acquire data collected in advance to train a neural network based on distributional reinforcement learning. The data acquisition module 102 may acquire data collected in advance from a memory of the learning device 100 or an external database, but is not limited thereto.

In an embodiment, the data acquisition module 102 may acquire a state in a specific environment, an action of an object determined according to the state, and a reward according to the action. The data acquisition module 102 may acquire data on the state, the action of the object, and the reward for each time step in each episode. Here, the specific environment may mean a simulation environment or an actual environment in which distributional reinforcement learning is implemented. For example, the specific environment may mean, but is not limited to, a work environment of a robot, a simulation environment of an autonomous vehicle, a military tactical simulation environment, etc.

In an embodiment, the data acquisition module 102 may acquire state information (e.g., the physical strength of enemy units, the distance between enemy units and friendly units, the remaining quantity of ammunition of friendly unit, etc.) for each time step in each episode on a simulator implementing a military operation environment. In addition, the data acquisition module 102 may acquire action information of an object (e.g., the ammunition type selection action of the friendly unit and the ammunition usage of the friendly unit, etc.) for each time step.

The data processing module 104 may process the data acquired by the data acquisition module 102 into a form suitable for use in distributional reinforcement learning in the learning module 106. The data processing module 104 may generate a data set for each time step. The data processing module 104 may generate a state, an action, and an n-step cumulative reward for each time step into one data set. The data processing module 104 may transmit the data set of each time step to the learning module 106.

In the disclosed embodiment, an n-step cumulative reward may be used rather than a reward for single time step. In this case, since a long-term reward is considered compared to the reward for single time step, future results may be better predicted. Here, the n-step cumulative reward may be a value obtained by accumulating rewards up to an n-th time step based on the current time step. The data processing module 104 may calculate the n-step cumulative reward for each time step based on the reward for each time step. The data processing module 104 may calculate n-step cumulative reward Gt through the following Equation 1.

$${G}_{t} = {\sum }_{k = 0}^{n - 1} {γ}^{k} {r}_{t + k} \qquad Equation l$$

γ: preset discount factor (depreciation rate)
rₜ₊ₖ: reward at time point (t+k)

The learning module 106 may include a neural network based on distributional reinforcement learning. The learning module 106 may train the neural network using a data set received from the data processing module 104.

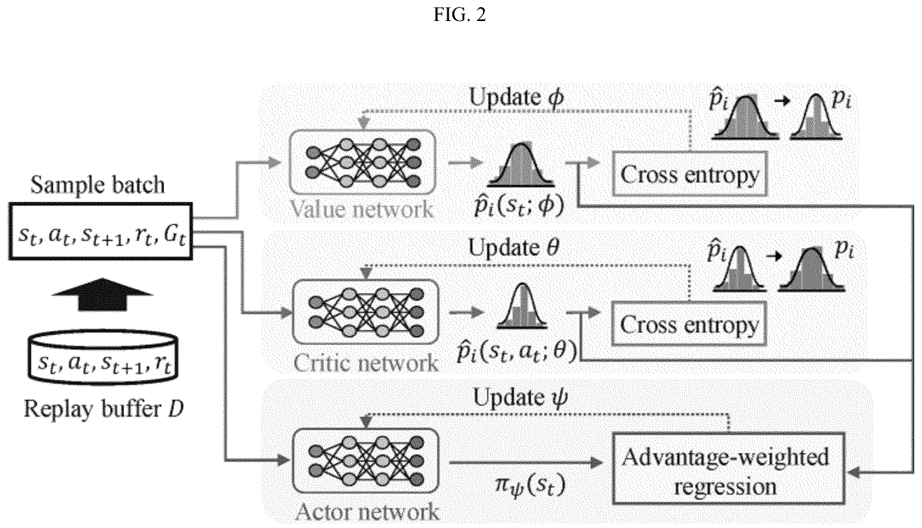

FIG. 2 is a diagram schematically illustrating a neural network based on distributional reinforcement learning and its learning operation according to an embodiment of the present disclosure. Referring to FIG. 2, the learning module 106 may include a neural network composed of a value network, a critic network, and an actor network.

Here, the value network is a network that outputs a value that may be obtained from a given state, and may output a first prediction value of a specific state by using the state as input. In addition, the critic network may output a second prediction value for an action in a specific state by using the state and the action as input. The actor network may output an action according to the current policy by using the state as input.

In this case, the prediction values output from the value network and the critic network become scalar values. In the disclosed embodiment, the prediction values output from the value network and the critic network may be expressed as categorical distributions rather than scalar values, thereby converting a regression problem into a classification problem.

Specifically, the learning module 106 may place a first additional layer and a second additional layer on an output terminal of the value network and an output terminal of the critic network, respectively. The learning module 106 may input the first prediction value output from the value network into the first additional layer to output M first logit values. Here, an estimation range for expressing the first prediction value as a distribution may be divided into M discrete intervals. In this case, a set of M discrete intervals may be expressed as

$${\{ {z}_{i} \}}_{i = 1}^{M}$$

(zᵢ is an i-th interval). Also, an output of the first additional layer (i.e., a first logit value) may be expressed by Equation 2

$${\{ {l}_{i} ( {s}_{t} ; ϕ ) \}}_{i = 1}^{M} \qquad Equation 2$$

sₜ: state at time point t
lᵢ: i-th logit value
M: number of logits
φ: parameter of first additional layer

The learning module 106 may apply a softmax function to each first logit value to calculate a first prediction probability distribution of each interval. The first prediction probability distribution \hat{p}ᵢ(sᵢ; φ) of each interval may be expressed by the following Equation 3. In this way, the learning module 106 may convert the first prediction value, which is a scalar value, into the first prediction probability distribution for each interval.

$${\hat{p}}_{i} ( {s}_{t} ; ϕ ) = \frac{exp ( {l}_{i} ( {s}_{t} ; ϕ ) )}{{\sum }_{m = 1}^{M} exp ( {l}_{m} ( {s}_{t} ; ϕ ) )} \qquad Equation 3$$

In addition, the learning module 106 may input a second prediction value output from the critic network into a second additional layer to output M second logit values. An output of the second additional layer (i.e., a second logit value) may be expressed by Equation 4.

$${\{ {l}_{i} ( {s}_{t} , {a}_{t} ; θ ) \}}_{i = 1}^{M} \qquad Equation 4$$

aₗ: action at time point t
θ: parameter of second additional layer

The learning module 106 may apply a softmax function to each second logit value to calculate a second prediction probability distribution of each interval. The second prediction probability distribution \hat{p}ᵢ(sᵢ; φ) of each interval may be expressed by Equation 5 below. In this way, the learning module 106 may convert the second prediction value, which is a scalar value, into the second prediction probability distribution for each interval.

$${\hat{p}}_{i} ( {s}_{t} , {a}_{t} ; θ ) = \frac{exp ( {l}_{i} ( {s}_{t} , {a}_{t} ; θ ) )}{{\sum }_{m = 1}^{M} exp ( {l}_{m} ( {s}_{t} , {a}_{t} ; θ ) )} \qquad Equation 5$$

The learning module 106 may convert a first target value corresponding to the first prediction value into a first target probability distribution in order to update parameters of the value network. In addition, the learning module 106 may convert a second target value corresponding to the second prediction value into a second target probability distribution in order to update parameters of the critic network. That is, the learning module 106 may convert the first target value into the first target probability distribution of the same category as the first prediction probability distribution, and convert the second target value into the second target probability distribution of the same category as the second prediction probability distribution.

Meanwhile, the first target value at time point t (current time step) may be set based on the n-step cumulative reward and the first prediction value of the value network for an n-th time step based on the time point t. The first target value

$${\overline{V}}_{t}^{( n )}$$

may be expressed by the following Equation 6. The first target value expressed by Equation 6 is a scalar value.

$${\overline{V}}_{t}^{( n )} = {\sum }_{k = 0}^{n - 1} {γ}^{k} {r}_{t + k} + {γ}^{n} {V}_{ϕ} ( {s}_{t + n} ) \qquad Equation 6$$

$${\sum }_{k = 0}^{n - 1} {γ}^{k} {r}_{t + k} :$$

n-step cumulative reward:
V_{φ}(sₜ₊ₙ) first prediction value of value network for n-th time step based on time point t
γ: preset discount factor (depreciation rate)

In addition, the second target value at time point t (current time step) may be set based on the reward at time point t and the first prediction value of the value network for the next time step (time point (t+1)). The second target value Q̅ₜ may be expressed by the following Equation 7. The second target value expressed by Equation 7 is a scalar value.

$${\overline{Q}}_{t} = {r}_{t} + {γV}_{∅} ( {s}_{t + 1} ) \qquad Equation 7$$

rₜ: reward at time point t
V_{ø}(sₜ₊₁): first prediction value of value network at time point (t+1)

The learning module 106 may generate a first normal distribution by applying a Gaussian normal distribution to the first target value, and generate a second normal distribution by applying a Gaussian normal distribution to the second target value. In this case, the first normal distribution may be a normal distribution having the first target value as an average, and the second normal distribution may be a normal distribution having the second target value as an average.

The learning module 106 may define a first probability variable Y|sₜ that follows the first normal distribution when a state sₜ is given, and a second probability Y|sₜ,aₜ variable that follows the second normal distribution when the state sₜ and an action aₜ are given. The first probability variable Y|sₜ and the second probability variable Y|sₜ,aₜ may may be expressed by Equations 8 and 9, respectively.

$$Y \vert {s}_{t} \sim 𝒩 ( {\overline{V}}_{t}^{( n )} , {σ}^{2} ) \qquad Equation 8$$

$$Y \vert {s}_{t} , {a}_{t} \sim 𝒩 ( {\overline{Q}}_{t} , {σ}^{2} ) \qquad Equation 9$$

Here, σ represents the variance of each normal distribution.

The learning module 106 may divide ranges of the first normal distribution and the second normal distribution into M intervals, respectively. The learning module 106 may divide an interval between a minimum value and a maximum value of the first normal distribution into M intervals, and divide an interval between a minimum value and a maximum value of the second normal distribution into M intervals. In this case, a width of the interval may be expressed as ζ=(νₘₐₓ−νₘᵢₙ)/M. Here, νₘₐₓ is the maximum value of the corresponding normal distribution, and νₘᵢₙ is the minimum value of the corresponding normal distribution.

The learning module 106 may calculate the first target probability distribution for each interval by integrating the first normal distribution for each interval of the first normal distribution. Here, the first target probability distribution pᵢ(sᵢ; φ) for each interval may be expressed by Equation 10.

$${p}_{i} ( {s}_{t} ; ϕ ) = {\int }_{{z}_{i} - ϛ / 2}^{{z}_{i} + ϛ / 2} {f}_{Y \vert {s}_{t}} ( y \vert {s}_{t} ) dy = {F}_{Y \vert {s}_{t}} ( {z}_{i} + ϛ / 2 \vert {s}_{t} ) - {F}_{Y \vert {s}_{t}} ( {z}_{i} + ϛ / 2 \vert {s}_{t} ) \qquad Equation 10$$

ƒ_{Y|s}_{ₜ}: probability density function of first normal distribution
zᵢ: center of i-th interval
F_{Y|s}_{ₜ}: cumulative distribution function of first normal distribution

The learning module 106 may calculate the second target probability distribution for each interval by integrating the second normal distribution for each interval of the second normal distribution. Here, the second target probability distribution pᵢ(sᵢ,aᵢ; θ) for each interval may be expressed by Equation 11.

$${p}_{i} ( {s}_{t} , {a}_{t} ; θ ) = {\int }_{{z}_{i} - ϛ / 2}^{{z}_{i} + ϛ / 2} {f}_{Y \vert {s}_{t} , {a}_{t}} ( y \vert {s}_{t} , {a}_{t} ) dy = {F}_{Y \vert {s}_{t} , {a}_{t}} ( {z}_{i} + ϛ / 2 \vert {s}_{t} , {a}_{t} ) - {F}_{Y \vert {s}_{t} , {a}_{t}} ( {z}_{i} + ϛ / 2 \vert {s}_{t} , {a}_{t} ) \qquad Equation 11$$

ƒ_{Y|s}_{ᵢ}_{,a}_{ᵢ}: probability density function of second normal distribution
F_{Y|s}_{ᵢ}_{,a}_{ᵢ}: cumulative distribution function of second normal distribution

Through this process, the first target value and the second target value, which are scalar values, may be converted into the same category as the first prediction probability distribution and the second prediction probability distribution, respectively.

The learning module 106 may train the value network (update the parameters of the value network) based on the first prediction probability distribution for each interval and the first target probability distribution for each interval of the value network. In an embodiment, the learning module 106 may train the value network by the cross entropy (CE) loss between the first prediction probability distribution for each interval and the first target probability distribution for each interval. This may be expressed by Equation 12.

$$CE ( ϕ ) = 𝔼 [ {\sum }_{i = 1}^{M} {p}_{i} ( {s}_{t} ; ϕ ) log {\hat{p}}_{i} ( {s}_{t} ; ϕ ) ] \qquad Equation 12$$

M: number of intervals
\hat{p}ᵢ(sᵢ; φ): first prediction probability distribution of i-th interval
pᵢ(sᵢ; φ): first target probability distribution of i-th interval

The learning module 106 may train the critic network based on the second prediction probability distribution for each interval and the second target probability distribution for each interval of the critic network. In an embodiment, the learning module 106 may train the critic network by the cross entropy loss between the second prediction probability distribution for each interval and the second target probability distribution for each interval. This may be expressed by Equation 13.

$$CE ( θ ) = 𝔼 [ {\sum }_{i = 1}^{M} {p}_{i} ( {s}_{t} , {a}_{t} ; θ ) log {\hat{p}}_{i} ( {s}_{t} , {a}_{t} ; θ ) ] \qquad Equation 13$$

\hat{p}ᵢ(sᵢ,aᵢ; θ): second prediction probability distribution of i-th interval
pᵢ(sᵢ,aᵢ; θ): second target probability distribution of i-th interval

In addition, the learning module 106 may train the actor network so that a difference between an action π(sₜ) predicted by the actor network and the action at in the data set is minimized. In this case, the learning module 106 may use an advantage function to weight to follow an action having a high value. The advantage function may be set as a difference between a prediction value \hat{Q}_{θ}(sᵢ,aᵢ) of the critic network and a prediction value \hat{V}_{φ}(sₜ) of the value network. That is, the actor network may be trained by a loss function expressed by the following Equation 14.

$${L}_{π} ( ψ ) = {𝔼}_{( {s}_{t} , {a}_{t} ) \sim D} [ exp ( β ( {\hat{Q}}_{θ} ( {s}_{t} , {a}_{t} ) - {\hat{V}}_{ϕ} ( {s}_{t} ) ) {‖ {a}_{t} - {π}_{ψ} ( {s}_{t} ) ‖}^{2} ] \qquad Equation 14$$

\hat{Q}_{θ}(sₜ,aₜ)−\hat{V}_{φ}(sₜ): advantageous function
β: hyperparameter that controls sensitivity to advantage function

Here, the prediction value \hat{V}_{φ}(sₜ) of the value network may use a mode value of the first prediction probability distribution \hat{p}ᵢ(sᵢ,aᵢ; φ) of each interval. Here, the mode value may mean a value with the highest prediction probability in each interval. The prediction value \hat{V}_{φ}(sₜ) of the value network used in the advantage function may be expressed by the following Equation 15.

$${\hat{V}}_{ϕ} ( {s}_{t} ) = {z}_{{argmax}_{i} {\hat{p}}_{i} ( {s}_{t} ; ϕ )} \qquad Equation 15$$

In addition, the prediction value \hat{Q}_{θ}(sₜ,aₜ) of the critic network may use a mode value of the second prediction probability distribution \hat{p}ᵢ(sᵢ,aᵢ; θ) of each interval. Here, the mode value may mean the value with the highest prediction probability in each interval. The prediction value \hat{Q}_{θ}(sᵢ,aᵢ) of the critic network used in the advantage function may be expressed by the following Equation 16.

$${\hat{Q}}_{θ} ( {s}_{t} , {a}_{t} ) = {z}_{{argmax}_{i} {\hat{p}}_{i} ( {s}_{t} , {a}_{t} ; θ )} \qquad Equation 16$$

According to the disclosed embodiment, by integrating distributional reinforcement learning and n-step cumulative reward-based learning structure in an offline environment, it is possible to achieve a technical effect that can simultaneously improve the accuracy, stability, and resource efficiency of decision making.

Specifically, by applying the offline reinforcement learning method, it is possible to stably learn a policy by utilizing past simulation data or real-world data without real-time interaction. In addition, by adopting the distributional reinforcement learning technique, it is possible to more precisely reflect uncertainty and high-risk situations in a specific environment. In addition, by introducing the n-step cumulative reward method, it becomes possible to select strategic actions that take into account long-term results, rather than being limited to short-term rewards.

In this specification, the term “module” may mean a functional and structural combination of hardware for performing the technical idea of the present invention and software for operating the hardware. For example, the “module” may mean a logical unit of a given code and hardware resources for performing the given code, and does not necessarily mean physically connected code or a type of hardware.

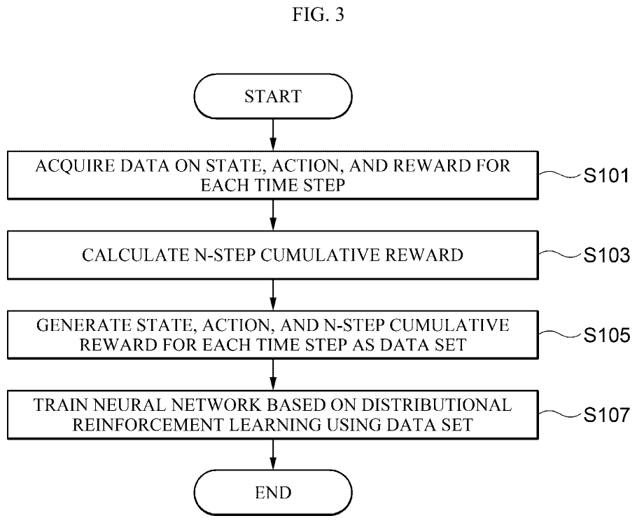

FIG. 3 is a flowchart describing a distributional reinforcement learning method for decision making in an offline environment according to an embodiment of the present disclosure. Although the method is described as being divided into a plurality of steps in the illustrated flowchart, at least some of the steps may be performed in a different order, performed together by being combined with other steps, omitted, performed by being divided into sub-steps and, or performed by adding one or more steps (not shown).

Referring to FIG. 3, the distributional reinforcement learning device 100 may acquire data on a state, an action of an object, and a reward for each time step in each episode for a preset environment (S 101).

Next, the distributional reinforcement learning device 100 may calculate an n-step cumulative reward for each time step based on the reward for each time step (S 103), and may generate the state, action, and n-step cumulative reward for each time step as one data set (S 105).

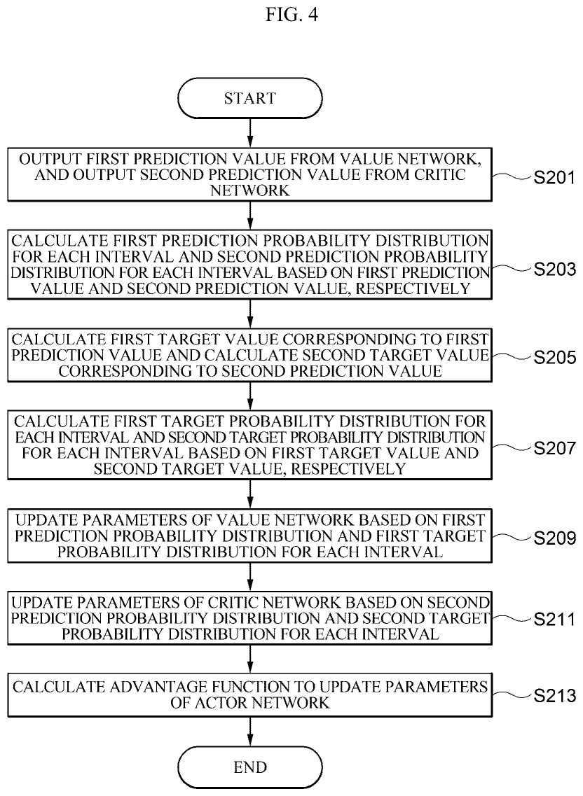

Next, the distributional reinforcement learning device 100 may train a neural network based on distributional reinforcement learning using the data set consisting of the state, action, and n-step cumulative reward for each time step (S 107). This will be described below with reference to FIG. 4.

FIG. 4 is a flowchart showing a specific method for training the neural network based on distributional reinforcement learning according to an embodiment of the present disclosure. Although the method is described as being divided into a plurality of steps in the illustrated flowchart, at least some of the steps may be performed in a different order, performed together by being combined with other steps, omitted, performed by being divided into sub-steps and, or performed by adding one or more steps (not shown).

Referring to FIG. 4, the distributional reinforcement learning device 100 may input a state from a data set into a value network to output a first prediction value therefrom, and input the state and an action from the data set into a critic network to output a second prediction value therefrom (S 201).

Next, the distributional reinforcement learning device 100 may calculate a first prediction probability distribution for each interval and a second prediction probability distribution for each interval based on the first prediction value and the second prediction value, which are scalar values, respectively (S 203).

Next, the distributional reinforcement learning device 100 may calculate a first target value corresponding to the first prediction value and a second target value corresponding to the second prediction value (S 205).

Next, the distributional reinforcement learning device 100 may calculate a first target probability distribution for each interval and a second target probability distribution for each interval based on the first target value and the second target value, which are scalar values, respectively (S 207).

Next, the distributional reinforcement learning device 100 may update parameters of the value network based on the first prediction probability distribution and the first target probability distribution for each interval (S 209).

Next, the distributional reinforcement learning device 100 may update parameters of the critic network based on the second prediction probability distribution and the second target probability distribution for each interval (S 211).

Next, the distributional reinforcement learning device 100 may calculate an advantage function using a mode value of the first prediction probability distribution for each interval and a mode value of the second prediction probability distribution for each interval, and update parameters of an actor network based on the calculated advantage function (S 213).

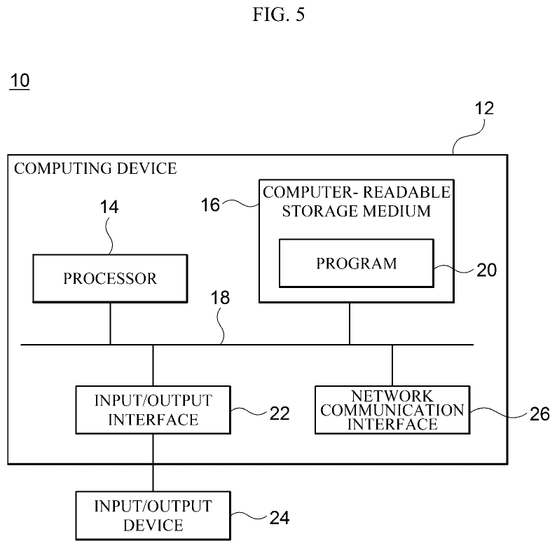

FIG. 5 is a block diagram for illustrating a computing environment 10 including a computing device suitable for use in exemplary embodiments. In the illustrated embodiment, respective components may have different functions and capabilities other than those described below, and include additional components in addition to those described below.

The illustrated computing environment 10 includes a computing device 12. In an embodiment, the computing device 12 may be the distributional reinforcement learning device 100.

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. The one or more programs may include one or more computer-executable instructions, which, when executed by the processor 14, may be configured so that the computing device 12 performs operations according to the exemplary embodiment.

The computer-readable storage medium 16 is configured to store the computer-executable instruction or program code, program data, and/or other suitable forms of information. A program 20 stored in the computer-readable storage medium 16 includes a set of instructions executable by the processor 14. In an embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a speech or sound input device, input devices such as various types of sensor devices and/or photographing devices, and/or output devices such as a display device, a printer, a speaker, and/or a network card. The exemplary input/output device 24 may be included inside the computing device 12 as a component configuring the computing device 12, or may be connected to the computing device 12 as a separate device distinct from the computing device 12.

According to the disclosed embodiment, by integrating distributional reinforcement learning and n-step cumulative reward-based learning structure in an offline environment, it is possible to achieve a technical effect that can simultaneously improve the accuracy, stability, and resource efficiency of decision making.

Specifically, by applying the offline reinforcement learning method, it is possible to stably learn a policy by utilizing past simulation data or real-world data without real-time interaction. In addition, by adopting the distributional reinforcement learning technique, it is possible to more precisely reflect uncertainty and high-risk situations in a specific environment. In addition, by introducing the n-step cumulative reward method, it becomes possible to select strategic actions that take into account long-term results, rather than being limited to short-term rewards.

Although representative embodiments of the present invention have been described in detail above, those skilled in the art will understand that various modifications may be made to the above-described embodiments without departing from the scope of the present invention. Therefore, the scope of the present invention should not be limited to the described embodiments, but should be defined not only by the patent claims described below but also by those equivalent to the patent claims.

What is claimed is:

1. A learning method performed on a computing device that includes one or more processors and a memory storing one or more programs executed by the one or more processors, the learning method comprising:
generating a data set by acquiring data on a state, an action, and a reward for each time step for a preset environment; and
training a neural network including a value network, a critic network, and an actor network based on the data set,
wherein the training of the neural network includes:
inputting a state to the value network and outputting a first prediction value, which is a scalar value;
converting the first prediction value into a first prediction probability distribution for each interval based on the first prediction value;
calculating a first target value, which corresponds to the first prediction value and is a scalar value;
converting the first target value into a first target probability distribution for each interval based on the first target value; and
updating parameters of the value network based on the first prediction probability distribution and the first target probability distribution.

2. The learning method of claim 1, wherein the converting into the first prediction probability distribution includes:
inputting the first prediction value output from the value network into a first additional layer connected to an output terminal of the value network to output first logit values of a plurality of intervals; and
calculating the first prediction probability distribution of each interval by applying a softmax function to each of the first logit values.

3. The learning method of claim 1, wherein the generating of the data set may include calculating an n-step cumulative reward for each time step based on the reward for each time step, and
in the calculating of the first target value, the first target value may be calculated based on an n-step cumulative reward for the current time step and the first prediction value of the value network for an n-th time step based on the current time step.

4. The learning method of claim 3, wherein the converting into the first target probability distribution includes:
generating a first normal distribution, which is a normal distribution having the first target value as an average;
dividing an interval between a minimum value and a maximum value of the first normal distribution into a plurality of intervals; and
calculating a first target probability distribution for each interval by integrating the first normal distribution for each interval of the first normal distribution.

5. The learning method of claim 1, wherein the training of the neural network further includes:
inputting a state and an action to the critic network and outputting a second prediction value, which is a scalar value;
converting the second prediction value into a second prediction probability distribution for each interval based on the second prediction value;
calculating a second target value, which is a scalar value and corresponds to the second prediction value;
converting the second target value into a second target probability distribution for each interval based on the second target value; and
updating parameters of the critic network based on the second prediction probability distribution and the second target probability distribution.

6. The learning method of claim 5, wherein the converting into the second prediction probability distribution includes:
inputting the second prediction value output from the critic network into a second additional layer connected to an output terminal of the critic network to output second logit values of a plurality of intervals; and
calculating the second prediction probability distribution of each interval by applying a softmax function to each of the second logit values.

7. The learning method of claim 5, wherein, in the calculating of the second target value, the second target value is calculated based on a reward for the current time step and the first prediction value of the value network for the next time step.

8. The learning method of claim 7, wherein the converting into the second target probability distribution includes:
generating a second normal distribution which is a normal distribution having the second target value as an average;
dividing an interval between a minimum value and a maximum value of the second normal distribution into a plurality of intervals; and
calculating a second target probability distribution for each interval by integrating the second normal distribution for each interval of the second normal distribution.

9. The learning method of claim 5, further comprising:
inputting a state into the actor network and outputting a predicted action;
calculating an advantage function based on a difference between a mode value of the first prediction probability distribution for each interval and a mode value of the second prediction probability distribution for each interval; and
updating parameters of the actor network based on a difference between the predicted action and the action in the data set and the advantage function.

10. A computing device comprising:
one or more processors;
a memory; and
one or more programs,
wherein the one or more programs are stored in the memory and configured to be executed by the one or more processors, and
the one or more programs include:
an instruction for generating a data set by acquiring data on a state, an action, and a reward for each time step for a preset environment; and
an instruction for training a neural network including a value network, a critic network, and an actor network based on the data set, and
the instruction for training the neural network includes:
an instruction for inputting a state to the value network and outputting a first prediction value, which is a scalar value;
an instruction for converting the first prediction value into a first prediction probability distribution for each interval based on the first prediction value;
an instruction for calculating a first target value, which is a scalar value corresponding to the first prediction value;
an instruction for converting the first target value into a first target probability distribution for each interval based on the first target value; and
an instruction for updating parameters of the value network based on the first prediction probability distribution and the first target probability distribution.

11. The computing device of claim 10, wherein the instruction for converting into the first prediction probability distribution includes:
an instruction for inputting the first prediction value output from the value network into a first additional layer connected to an output terminal of the value network to output first logit values of a plurality of intervals; and
an instruction for calculating the first prediction probability distribution of each interval by applying a softmax function to each of the first logit values.

12. The computing device of claim 10, wherein the instruction for converting into the first target probability distribution includes:
an instruction for generating a first normal distribution, which is a normal distribution having the first target value as an average;
an instruction for dividing an interval between a minimum value and a maximum value of the first normal distribution into a plurality of intervals; and
an instruction for calculating a first target probability distribution for each interval by integrating the first normal distribution for each interval of the first normal distribution.

13. The computing device of claim 10, wherein the instruction for training the neural network further includes:
an instruction for inputting a state and an action to the critic network and outputting a second prediction value, which is a scalar value;
an instruction for converting the second prediction value into a second prediction probability distribution for each interval based on the second prediction value;
an instruction for calculating a second target value, which is a scalar value and corresponds to the second prediction value;
an instruction for converting the second target value into a second target probability distribution for each interval based on the second target value; and
an instruction for updating parameters of the critic network based on the second prediction probability distribution and the second target probability distribution.

14. The computing device of claim 13, wherein the instruction for training the neural network further includes:
an instruction for inputting a state into the actor network and outputting a predicted action;
an instruction for calculating an advantage function based on a difference between a mode value of the first prediction probability distribution for each interval and a mode value of the second prediction probability distribution for each interval; and
an instruction for updating parameters of the actor network based on a difference between the predicted action and the action in the data set and the advantage function.

15. A computer program stored in a non-transitory computer readable storage medium, wherein the computer program includes one or more instructions, and the instructions, when executed by a computing device including one or more processors, cause the computing device to perform:
generating a data set by acquiring data on a state, an action, and a reward for each time step for a preset environment; and
training a neural network including a value network, a critic network, and an actor network based on the data set, and
the training of the neural network includes:
inputting a state to the value network and outputting a first prediction value, which is a scalar value;
converting the first prediction value into a first prediction probability distribution for each interval based on the first prediction value;
calculating a first target value, which corresponds to the first prediction value and is a scalar value;
converting the first target value into a first target probability distribution for each interval based on the first target value; and
updating parameters of the value network based on the first prediction probability distribution and the first target probability distribution.
